(19) United States
(12) Patent Application Publication
(10) Pub. No.: US 2015/0360370 A1
(43) Pub. Date: Dec. 17, 2015

(54) THIN END EFFECTOR WITH ABILITY TO HOLD WAFER DURING MOTION

(71) Applicants: John Mazzocco, San Jose, CA (US); Daniel Greenberg, San Jose, CA (US)

(72) Inventors: John Mazzocco, San Jose, CA (US); Daniel Greenberg, San Jose, CA (US)

(21) Appl. No.: 14/307,385

(22) Filed: Jun. 17, 2014

(51) Int. Cl. B25J 15/00; B25J 15/06; B25J 18/00

(52) U.S. Cl. CPC B25J 15/0023; B25J 15/0028; B25J 18/00; B25J 15/0608; B25J 15/0616; Y10S 901/31; Y10S 901/40

(57) ABSTRACT

Embodiments of the invention include methods and apparatuses for removing a carrier ring assembly from a carrier that includes tightly pitched slots. Embodiments include a robot arm that comprises an end effector wrist, an end effector that has a maximum thickness less than approximately 3.0 mm and a gripping device for securing a carrier ring assembly to the end effector. According to an embodiment, the gripping device may be a clamping member. One or more actuators may be used to displace the clamping member in a direction relative to the end effector. In an additional embodiment, the gripping device may be an electromagnetic device that includes a plurality of electromagnets that are inserted into a top surface of the end effector. Embodiments further include a vacuum gripping device that includes openings in a top surface of the end effector that are coupled to a vacuum controller by air-lines.

### BACKGROUND

1) Field

Embodiments of the present invention pertain to the field of semiconductor processing and, in particular, to methods and apparatuses for transferring carrier ring assemblies.

2) Description of Related Art

Production scale semiconductor fabrication is typically performed in highly automated fabrication plants. An automated material handling system (AMHS) transfers substrates, such as silicon wafers, between processing and metrology tools in substrate carriers, such as front opening unified pods (FOUPs) and cassettes. A factory interface is added onto tools in order to interface with the AMHS. A wafer handling robot within the factory interface is designed to remove substrates from the substrate carrier and transfer the substrate to the tool for processing.

FIG. 1A is a cross-sectional illustration of a FOUP 110 that includes slots 120 for storing substrates. The slots 120 may be formed along sidewalls 112 of the FOUP 110 and support the substrates 122 along their edges. A FOUP 110 designed for use with 300 mm wafers may have slots 120 that are spaced apart from each other by a pitch P of approximately 10 mm. The thickness of the substrates 122 stored in the slots 120 needs to be significantly smaller than the pitch P of the slots in order to allow the wafer handling robot within the factory interface to remove the substrate without contacting a neighboring substrate. For example, a 300 mm wafer may have a thickness of approximately 775 μm or less. The wafer handling robot in the factory interface is designed to be able to remove substrates that are spaced apart from each other by approximately 9 mm or greater. FIG. 1B is a cross-sectional illustration of FIG. 1A along line B-B. As shown, an end effector 119 that is coupled to a wafer handling robot (not show) is inserted below a bottom surface of the wafer 122 in order to lift the wafer up off of the slot 120. The end effector 119 has a thickness T that may be 5.0 mm or larger. Additionally, in order to secure the carrier ring assembly during the transfer process, an end effector may also include one or more fangs 123 that extend upwards from a top surface of the end effector. The fangs add additional height beyond the thickness T and may be 1.0 mm tall or greater.

However, when non-standard substrates are stored in a FOUP or cassette, the wafer handling robot within the factory interface may not be able to accommodate the different dimensions. For example, the slots 120 of a FOUP 110 may not be spaced at a pitch P large enough to allow a wafer handling robot to access non-standardized substrates that are thicker than a commercially available silicon wafer. The increased thickness reduces the clearance between substrates. Accordingly, the wafer handling robot within the factory interface may not be precise enough to remove the thicker substrates from a FOUP or cassette without contacting neighboring substrates.

### SUMMARY

Embodiments of the invention include methods and apparatuses for removing a carrier ring assembly from a carrier that includes tightly pitched slots. Embodiments include a robot arm that comprises an end effector wrist, an end effector that has a maximum thickness less than approximately 3.0 mm and a gripping device for securing a carrier ring assembly to the end effector. According to an embodiment, the gripping device may be a clamping member. In an embodiment, the clamping member extends out from the end effector wrist and is positioned above the end effector. For example, one or more actuators may be used to displace the clamping member in a direction relative to the end effector. According to an additional embodiment, the gripping device may comprise a plurality of clamping members.

In an additional embodiment, the gripping device may be an electromagnetic device. In such embodiments, the electromagnetic device may comprise a plurality of electromagnets that are inserted into a top surface of the end effector. The electromagnets may be coupled to a control circuit that can activate and deactivate the electromagnets. Embodiments further include a gripping device that may be a vacuum device. In such embodiments, the vacuum device may comprise one or more air-lines formed in the end effector and coupled to a vacuum controller in the end effector wrist that can control a vacuum pressure in the air-lines.

### BRIEF DESCRIPTION OF THE DRAWINGS

FIG. 1A is a cross-sectional illustration of a FOUP for carrying wafers.

FIG. 1B is a cross-sectional illustration of the FOUP in FIG. 1A along line B-B.

FIG. 2A is an overhead plan view illustration of a carrier ring assembly, according to an embodiment of the invention.

FIG. 2B is a cross-sectional illustration of the carrier ring assembly in FIG. 2A along line B-B, according to an embodiment of the invention.

FIG. 3A is an illustration of a block diagram of a processing tool, according to an embodiment of the invention.

FIG. 3B is a cross-sectional illustration of the processing tool in FIG. 3A along line B-B, according to an embodiment of the invention.

FIG. 4A is an overhead plan view illustration of a robot arm, according to an embodiment of the invention.

FIG. 4B is a cross-sectional illustration of a robot arm, according to an embodiment of the invention.

FIG. 4C is an overhead plan view illustration of a robot arm, according to an embodiment of the invention.

FIG. 4D is a cross-sectional illustration of a robot arm, according to an embodiment of the invention.

FIG. 4E is a cross-sectional illustration of a robot arm, according to an embodiment of the invention.

FIGS. 5A-5C are cross-sectional illustrations of a robot arm securing and removing a carrier ring assembly from a FOUP, according to an embodiment of the invention.

FIG. 6A is an overhead plan view illustration of a robot arm, according to an embodiment of the invention.

FIG. 6B is a cross-sectional illustration of the robot arm shown in FIG. 6A, according to an embodiment of the invention.

FIG. 7A is an overhead plan view illustration of a robot arm, according to an embodiment of the invention.

FIG. 7B is a cross-sectional illustration of the robot arm shown in FIG. 7A, according to an embodiment of the invention.

FIGS. 8A-8C illustrate cross-sectional views of a semiconductor wafer including a plurality of integrated circuits during a method of dicing a semiconductor wafer, according to an embodiment of the invention.

FIG. 9 illustrates a block diagram of an exemplary computer system, according to an embodiment of the invention.

### DETAILED DESCRIPTION

Methods and apparatuses used for transferring a carrier ring assembly with a robot arm comprising an end effector are described in accordance with various embodiments. In the following description, numerous specific details are set forth, such as carrier ring assemblies, wafer handling robots, end effectors, and semiconductor processing tools, in order to provide a thorough understanding of embodiments of the present invention. It will be apparent to one skilled in the art that embodiments of the present invention may be practiced without these specific details. In other instances, well-known aspects are not described in detail in order to not unnecessarily obscure embodiments of the invention. Furthermore, it is to be understood that the various embodiments shown in the Figures are illustrative representations and are not necessarily drawn to scale.

The thickness of a carrier ring complicates the transfer process between a first location and a second location inside a process tool. For example, FOUPs and cassettes designed to store carrier ring assemblies may have a slot pitch of approximately 10 mm. This is substantially the same slot pitch that is used in FOUPs for storing 300 mm substrates that are not being supported by a carrier ring. The increased thickness of the carrier ring assembly, as compared to a commercially available wafer, decreases the clearance between neighboring carrier ring assemblies. Accordingly, wafer handling robots and end effectors designed for removing commercially available wafers from FOUPs or cassettes do not have enough precision to remove the thicker carrier ring assemblies.

Accordingly, embodiments of the invention are directed at reducing the thickness of the end effector and reducing the amount that the end effector droops while securely supporting a carrier ring assembly while the end effector transfers the carrier ring assembly from a first location to a second location. For example, inclusion of a gripping device can eliminate the need for fangs on the end of the end effector. Furthermore, reducing the length of the end effector minimizes the effect of drooping when the end effector is supporting the carrier ring assembly.

Utilization of a robot arm comprising an end effector wrist and an end effector according to embodiments of the invention allow a standard wafer handling robot to be used for removing carrier ring assemblies from tightly pitched substrate carriers, such as FOUPs and cassettes. Accordingly, expensive redesign of the factory interface portion of a processing tool is not needed to accommodate carrier ring assemblies when embodiments of the invention are used.

Further, embodiments of the invention may include a gripping device that is capable of securing the carrier ring assembly to the end effector in order to prevent the carrier ring assembly from moving relative to the end effector. Movement of the carrier ring assembly relative to the end effector may result in the carrier ring assembly being improperly oriented when placed at the second location or even dropped by the robot arm. As such, the throughput of the processing tool may be increased by increasing the speed at which the robot arm transfers the carrier ring assembly.

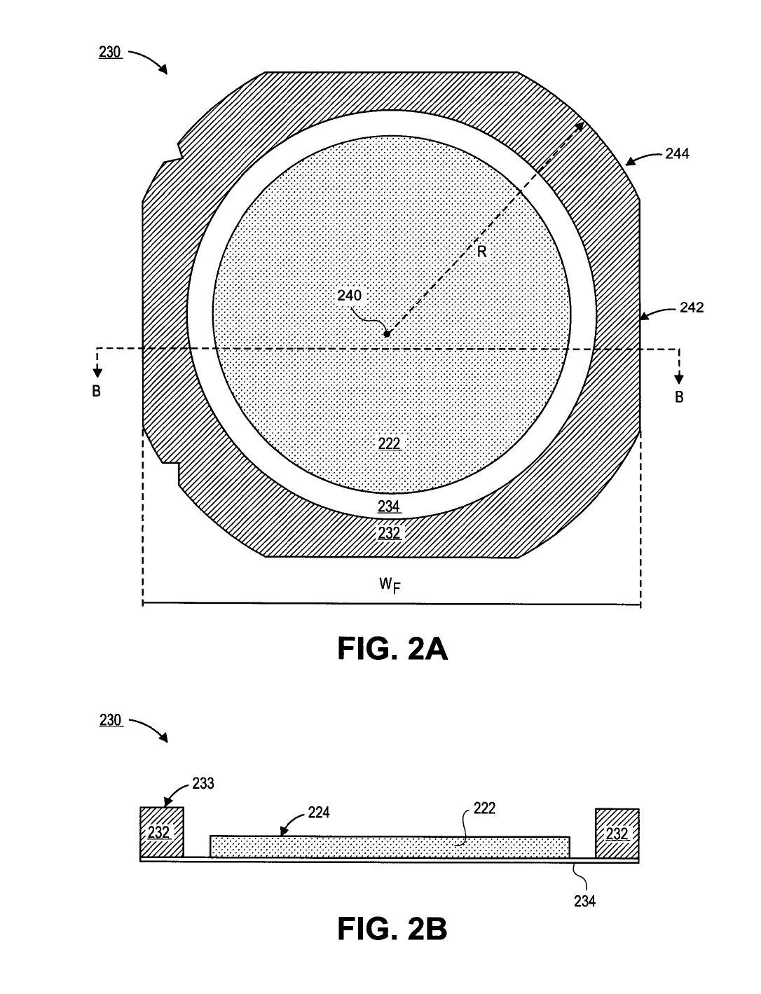

Referring now to FIG. 2A, a carrier ring assembly 230 is shown according to an embodiment. In an embodiment, the carrier ring assembly 230 includes a carrier ring 232, an adhesive backing tape 234 and a substrate 222. The layer of adhesive backing tape 234 is surrounded by the carrier ring 232. The substrate 222 is supported by the backing tape 234. In an embodiment, the carrier ring 232 may be a metallic material. For example, the carrier ring 232 may be a stainless steel. Embodiments include a carrier ring 232 that may be a magnetic material. In an additional embodiment, the carrier ring 232 may be a non-metallic material, such as a polymeric material or a resin. In an embodiment, the substrate 222 is a commercially available silicon wafer, such as a 300 mm silicon wafer. Additional embodiments include a carrier ring assembly 230 sized for carrying a larger or smaller substrate, such as 200 mm or 450 mm substrates. Substrate 222 may have a plurality of individual device dies (not shown) that each include integrated circuitry formed thereon.

In an embodiment, carrier ring 232 has one or more flat edges 242. As shown in FIG. 2A, the carrier ring 232 includes four flat edges 242. In an embodiment, the width of the carrier ring 232 between opposing flat edges W_{F} is approximately 380 mm, though embodiments are not limited to such configurations. For example, a carrier ring 232 for carrying a larger substrate 222 may have a width W_{F} greater than 380 mm. Embodiments include a carrier ring 232 that has rounded edges 244 that are formed between flat edges 242. In an embodiment, the rounded edges 244 are circular arcs with an origin at the center 240 of the carrier ring assembly 230. In an embodiment the radius R of the rounded edges 244 may be approximately 200 mm, though embodiments are not limited to such configurations. For example, a carrier ring 232 for carrying a larger substrate 222 may have rounded edges 244 that have a radius R greater than 200 mm. Accordingly, the width of the carrier ring 232 is variable depending on where the width of the carrier ring is taken. For example, the width between two points on opposite sides of the carrier ring 232 along the rounded edges 244 (i.e., 2R) is larger than the width W_{F} between two flat edges 242.

While specific reference is made herein to carrier ring assemblies 230 that include substrates 222 that are wafers, embodiments are not so limited. Substantially similar methods and apparatuses to those described herein may be used to transfer a carrier ring assembly 230 that supports substrates other than a single silicon wafer. For example, carrier ring assemblies 230 for carrying multiple substrates may be utilized according to embodiments of the invention. For example, a carrier ring assembly 230 utilized for processing light emitting diodes (LEDs) formed on a plurality of sapphire substrates may be transferred with robot arm according to an embodiment of the invention.

As illustrated in the cross-section view of the carrier ring assembly 230 along line B-B shown in FIG. 2B, embodiments of the invention include a carrier ring 232 that has a thickness that is greater than the thickness of the substrate 222. By way of example, the thickness of the carrier ring 232 may be 1.0 mm or greater. In one embodiment, the thickness of the carrier ring 232 may be between 1.0 mm and 5.0 mm. Accordingly, embodiments include a carrier ring assembly 230 in which a top surface 224 of the substrate 222 is recessed below a top surface 233 of the carrier ring 232. In an additional embodiment, the thickness of a carrier ring 232 does not have the same degree of thickness uniformity as a commercially available silicon wafer. For example, the variation in the thickness across a carrier ring 232 may be between 0.2 mm and 2.0 mm. Furthermore, the increased diameter of the carrier ring assembly 230 increases the amount the carrier ring assembly 230 will droop while it is resting on a slot in a carrier. Since the slots of a FOUP or cassette only support the carrier ring 230 along the edges, the effect of gravity produces a drooping effect across the unsupported span of the carrier ring assembly 230. This drooping further reduces the clearance between neighboring carrier ring assemblies 230. Accordingly, the increased thickness of the carrier ring assembly, the reduction in thickness uniformity of the carrier ring assembly, and the increased degree of drooping result in a decrease in the spacing between carrier ring assemblies 230 stored in a substrate carrier, such as a FOUP or a cassette. For example, the clearance between neighboring carrier ring assemblies 230 may be less than approximately 5.0 mm.

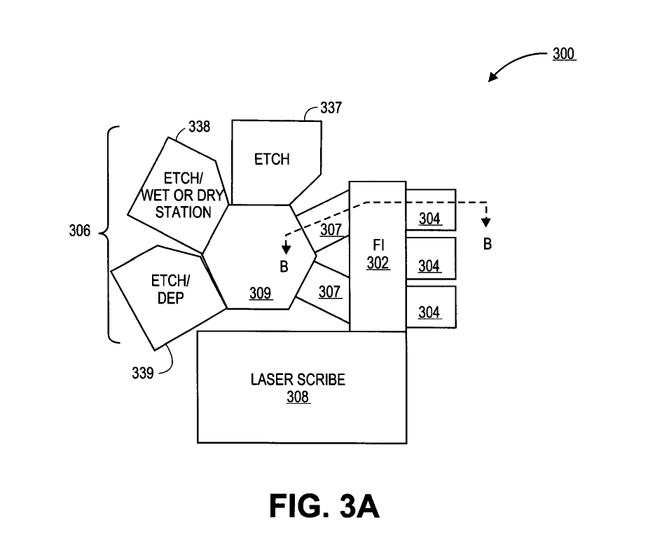

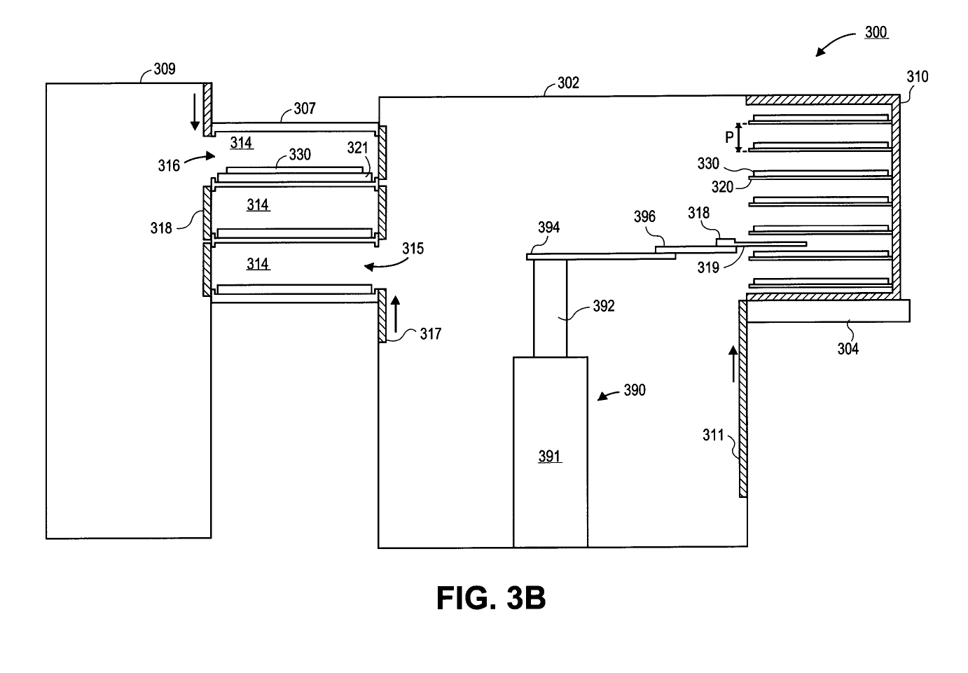

According to embodiments of the invention, the carrier ring assembly may support the substrate during a processing operation. For example, the carrier ring assembly may be processed in a processing tool such as one similar to the processing tool 300 illustrated in FIG. 3A. In an embodiment, a process tool 300 includes one or more load ports 304 and a factory interface 302. The process tool 300 may include a cluster tool 306 that is coupled to the factory interface 302 by load locks 307. The cluster tool includes a transfer chamber 309. The transfer chamber 309 may be maintained at a vacuum pressure in order to facilitate transfer of carrier ring assemblies between chambers without having to pump down the pressure between each processing operation. In an embodiment, a robot is located in the transfer chamber 309 and is configured to transfer carrier ring assemblies between the load locks 307 and a process chamber, or between different process chambers in a vacuum environment. In an embodiment, the cluster tool 306 also includes one or more plasma etch chambers 337. In an embodiment, the process tool 300 includes a laser scribe apparatus 308. A process tool 300 may be configured to perform a hybrid laser and etch singulation process of individual device dies formed on a substrate, such as a silicon wafer that is supported by a carrier ring.

In an embodiment, the laser scribe apparatus 308 houses a femtosecond-based laser. The femtosecond-based laser may be suitable for performing a laser ablation portion of a hybrid laser and etch singulation process of individual device dies formed on a substrate, such as a silicon wafer that is supported by a carrier ring. In one embodiment, a moveable stage is also included in the laser scribe apparatus 308, the moveable stage configured for moving a substrate supported by a carrier ring relative to the femtosecond-based laser. In another embodiment, the femtosecond-based laser is also moveable.

In an embodiment, the one or more plasma etch chambers 337 in the cluster tool 306 may be suitable for performing an etching portion of a hybrid laser and etch singulation process of individual device dies formed on a substrate, such as a silicon wafer that is supported by a carrier ring. An etch chamber may be configured for etching a substrate supported by a carrier ring through the gaps in a patterned mask. In one such embodiment, the one or more plasma etch chambers 337 in the cluster tool 306 is configured to perform a deep silicon etch process. In a specific embodiment, the one or more plasma etch chambers is an Applied Centura® Silvia™ Etch system, available from Applied Materials of Sunnyvale, Calif., USA. The etch chamber may be specifically designed for a deep silicon etch used to singulate integrated circuits housed on or in single crystalline silicon substrates or wafers. In an embodiment, a high-density plasma source is included in the plasma etch chamber to facilitate high silicon etch rates.

Cluster tool 306 may include other chambers suitable for performing functions in a method of singulation. For example, in one embodiment, in place of an additional etch chamber, a deposition chamber 339 is included. The deposition chamber 339 may be configured for mask deposition on or above a device layer of a wafer or a substrate prior to laser scribing of the wafer or substrate. In one such embodiment, the deposition chamber 339 is suitable for depositing a water soluble mask. In another embodiment, in place of an additional etch chamber, a wet/dry station 338 is included. The wet/dry station 338 may be suitable for cleaning residues and fragments, or for removing a water soluble mask, subsequent to a laser scribe and plasma etch singulation process of a substrate or a wafer. In an embodiment, a metrology station is also included as a component of process tool 300.

In an embodiment, the factory interface 302 may be a suitable atmospheric port to interface with the load ports 304, with the laser scribe tool 308, and with the load locks 307. The factory interface 302 may include one or more robots with robot arms and end effectors according to embodiments described in greater detail below. The one or more robot arms and one or more end effectors may be used for transferring carrier ring assemblies from FOUPs docked at the load ports 304 into either load locks 307 or laser scribe apparatus 308, or both.

Referring now to FIG. 3B, a cross-sectional schematic view along line B-B in FIG. 3A illustrates a transfer chamber 309, a load lock 307, a factory interface 302, and a load port 304 on which a FOUP 310 is positioned. According to an embodiment, the load lock 307 includes a plurality of compartments 314. In an embodiment, each compartment 314 may be coupled to one or more vacuum pumps that are capable of reducing the pressure in the compartment 314 to reach the pressure of the transfer chamber 309, such as a vacuum pressure. Each compartment may be vacuum tight and may be independently controllable (e.g., a first compartment may be held at a vacuum while a second compartment remains at atmospheric pressure). In an embodiment, a carrier ring assembly 330 may be inserted through a first opening 315 into the compartment 314 that is accessible to the robot when a first load lock door 317 is open. In an embodiment, the carrier ring assembly 330 may be placed on a pedestal 321 or slot within the compartment 314. The first door 317 may be closed (e.g., by being slid upwards as indicated by the arrow) and then the compartment 314 can be pumped down to an adequate vacuum. Once the vacuum pressure is reached, a second door 318 may be opened to allow a second robot (not shown) in the transfer chamber 309 to access the load lock compartment 314 through a second opening 316. Though three compartments 314 are shown, it should be recognized that the number of compartments 314 in the load lock 307 may be fewer or greater than what is illustrated in FIG. 3B.

According to an embodiment, one or more wafer handling robots 390 are located in the factory interface 302. In an embodiment, the robot 390 includes a robot drive 391. A robot shaft 392 may extend out of a top surface of the robot drive 391 in order to enable the robot to raise or lower the level of an end effector 319. In an embodiment, the robot shaft 392 is driven by a piston or a lead screw. According to an embodiment, the robot arm may be a selective compliance articulated robot arm (SCARA). For example, a first arm 394 is rotatably coupled to the robot shaft 392. A second arm 396 may be rotatably coupled to the free end of the first arm 394. An end effector wrist 318 may be rotatably coupled to the free end of the second arm 396. The end effector 319 may be coupled to the end effector wrist 318.

According to an embodiment, the robot 390 may access a FOUP 310 located at the load port 304. The FOUP 310 may include a door 311 that opens into the factory interface 302 and allows the carrier ring assemblies 330 that are stored on slots 320 to be accessible to the robot 390. For example, the door 311 may slide open and closed as indicated by the arrow. According to embodiments of the invention, the slots 320 are spaced apart from each other by a pitch P that is approximately 10 mm or less. Due to the increased thickness of the carrier ring assemblies 330, embodiments of the invention include a robot 390 with a robot arm that comprises an end effector wrist 318 and an end effector 319 according to embodiments described herein. The configuration, shape, and ability of the robot arm to secure the carrier ring assembly to the end effector 319 allows for the robot to transfer the carrier ring assembly from a first location to a second location. For example, the first location may be a FOUP 310 and the second location may be a load lock compartment 314. Additional embodiments include the load lock compartment 314 being the first location and a FOUP 310 being the second location. Further embodiments include the first and second positions being any location within the process tool that is accessible to the robot 390. For example, the laser scribe 308 may be either the first or second location according to certain embodiments.

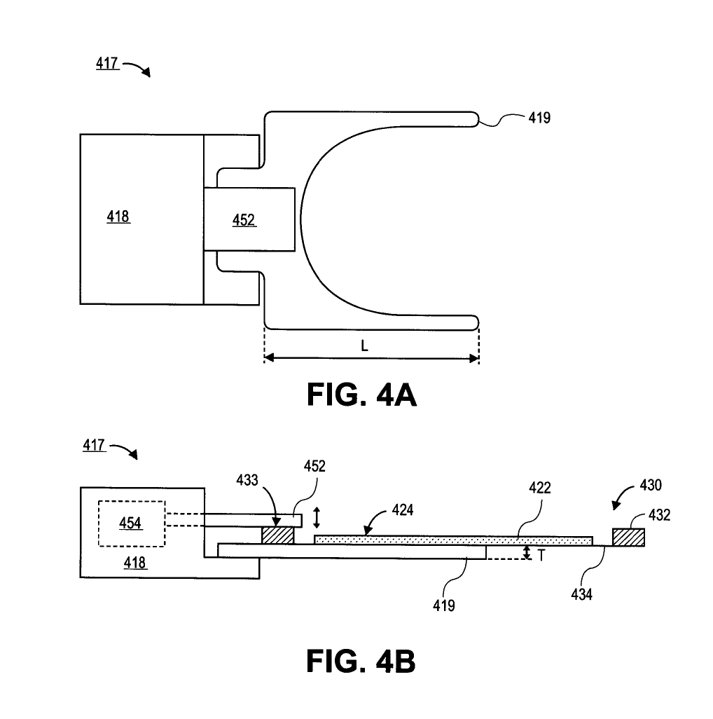

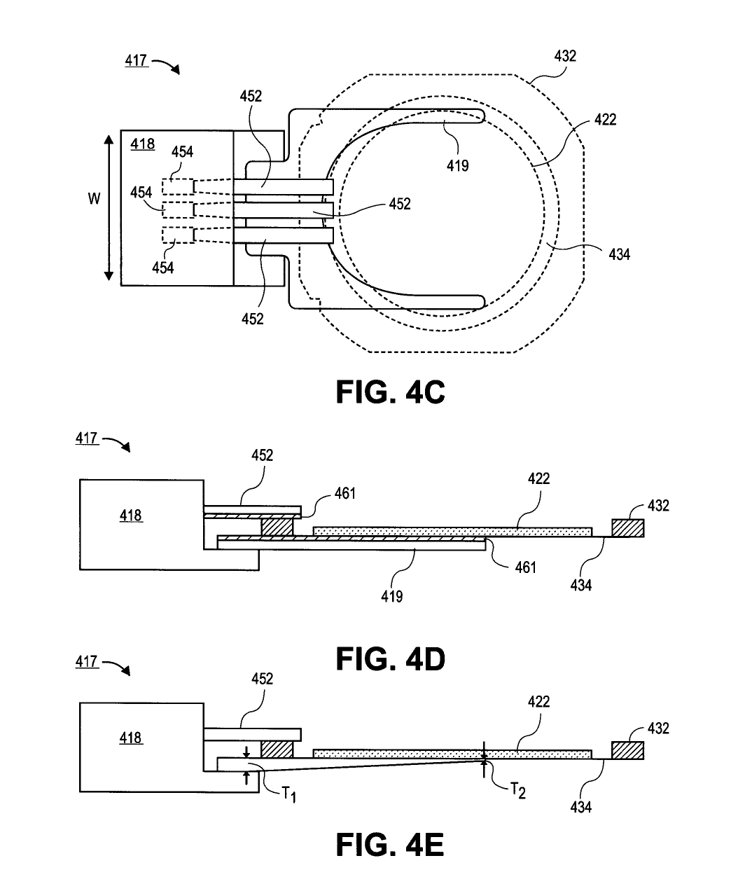

Referring now to FIG. 4A, an overhead plan view of a robot arm 417 according to an embodiment of the invention is illustrated. The robot arm 417 may be coupled to a robot, such as a robot similar to robot 390 described above. According to an embodiment, robot arm 417 may comprise an end effector wrist 418 and an end effector 419. In an embodiment, the end effector 419 is coupled to the end effector wrist 418 by one or more fasteners, such as screws, bolts, or similar fastening devices. Additional embodiments also include an end effector 419 that is formed as a single component with the end effector wrist 418. In an embodiment, the end effector 419 is a single component, though embodiments are not limited to such configurations. For example, the end effector 419 may comprise two or more distinct components that are each coupled to the end effector wrist 418 and which both extend outward from the end effector wrist 418. Robot arm 417 may also comprise a gripping device. In an embodiment, the gripping device may be a clamping member 452, as illustrated in FIG. 4A. In an embodiment, the clamping member 452 may extend outwards from the end effector wrist 418.

According to an embodiment, the end effector 419 is formed from a rigid material. For example, the end effector 419 may be a metallic material, a ceramic material, or a composite material. In embodiments of the invention, the end effector 419 may be made from titanium, aluminum, nickel plated aluminum, anodized aluminum, alumina, or carbon fiber. According to an embodiment, the end effector 419 may extend out from the end effector wrist 418 a length L. In one embodiment, the length L is chosen to minimize the extent of drooping caused by the mass of the end effector 419. As the length L increases, the mass of the end effector 419 will increase as well. Additionally, the center of mass of the end effector will be shifted further away from the end effector wrist 418. As such, a longer end effector 419 will result in a greater degree of drooping. Accordingly, reducing the length L of the end effector decreases the amount that the end effector 418 droops under its own weight. In an embodiment of the invention, the length L of the end effector 419 may be less than the width W_{F} of a carrier ring assembly. For example, the length L may be between one-half W_{F} and W_{F}. According to an additional embodiment, the length L may be between one-half W_{F} and two-thirds W_{F}. By way of example, the length L may be between 150 mm and 350 mm. An additional embodiment includes a length L that may be between 200 mm and 275 mm.

The robot arm 417 may further comprise a gripping device. The gripping device allows for the carrier ring assembly to be secured to the end effector 419 as it is being transferred between a first location and a second location. According to embodiments, the movement of a SCARA robot, such as robot 390, may move the robot arm with a speed and rotational acceleration that imparts an acceleration of approximately 10 m/s² or greater on the carrier ring assembly in order to obtain the desired throughput. However, the decrease in the length L of the end effector 419 reduces the contact area between the end effector 419 and the carrier ring assembly. As such, friction that resists the rotational acceleration is also decreased.

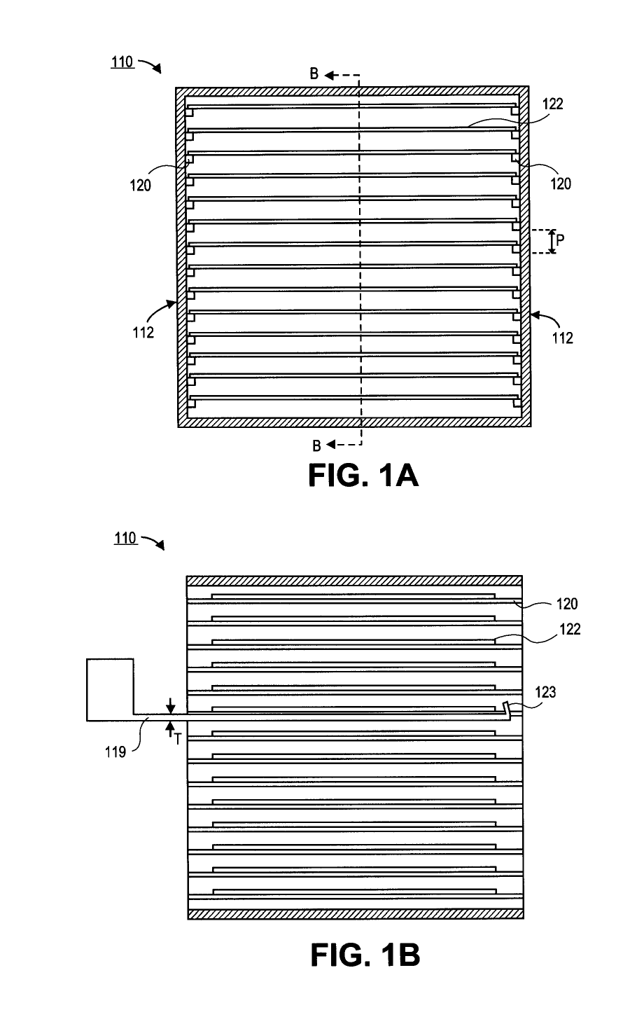

Furthermore, embodiments of the invention may not include fangs, such as those described above with respect to FIG. 1B, that extend upwards from a top surface of the end effector. As such, without a gripping device the carrier ring assembly may not be securely attached to the end effector 419 and the carrier ring assembly may move relative to the end effector 419 while it is being transferred from a first location to a second location. Movement of the carrier ring assembly may result in the carrier ring assembly being improperly oriented when placed at the second location or even dropped by the robot arm 417. When transferring carrier ring assemblies, proper orientation becomes critical because the difference in the widths of the carrier ring present additional problems that are not encountered when transferring substantially circular substrates. For example, an opening in a FOUP or a load lock may be sized to receive a carrier ring that is oriented such that its narrowest width (i.e., W_{F} between the flat edges) fits through the FOUP opening. If the carrier ring assembly moves and becomes improperly oriented, then the carrier ring assembly may not fit through an opening.

In an embodiment, the gripping device may include one or more clamping members 452 that extend out from the end effector wrist 418. FIG. 4B is a cross-sectional view of robot arm 417 according to an embodiment of the invention. In an embodiment, the clamping member 452 may be displaced relative to the end effector 419. As indicated by the arrows, the clamping member 452 may be displaced in the Y-direction. According to an embodiment, the clamping member 452 may be controlled by one or more actuators 454 located within the end effector wrist. As indicated by the dashed lines extending between the actuator 454 and the clamping member 452, the clamping member may extend into the end effector wrist 418 in order to attach to the actuator 454. In an embodiment, the one or more actuators 454 may be an electric actuator or a pneumatic actuator. In embodiments that utilizes a pneumatic actuator, the air-lines used to drive the actuator may already be present in the end effector wrist 418, and as such will not add additional complexity to the apparatus. For example, the air-lines may be used for a vacuum gripping system (described in greater detail below), or for driving pneumatic actuators that control the position of the robot arm 417.

According to embodiments of the invention, the clamping member extends outwards a sufficient distance to be able to contact a top surface 433 of the carrier ring 432. Contacting the carrier ring 432 is beneficial because the integrated circuitry or active devices are formed on the substrate 422. Unlike robot arms that transfer wafers, robot arms according to embodiments described herein are able to make contact with the top surface of the workpiece that is being transferred. Whereas the active device circuitry of a wafer may be damaged by clamping the top surface 424 of the wafer, embodiments of the present invention can securely clamp the top surface 433 of the carrier ring 432. Additionally, even if the clamping member extends beyond the carrier ring 432, the top surface of the substrate 422 would not be harmed. The substrate 422 may not be as thick as the carrier ring 432 and the top surface 424 of the substrate 422 is, therefore, recessed below the top surface 433 of the carrier ring 432. As such, the clamping member may be prevented from touching the top surface of the substrate 422 by the thicker carrier ring 432, thereby protecting integrated circuitry that may be formed on the top surface of the substrate 422.

Embodiments of the invention may include an end effector 419 that has a maximum thickness T. The thickness T may be minimized in order to increase the amount of clearance between neighboring carrier ring assemblies 330 stored on slots 320 in a FOUP 310, as shown in FIG. 3B. For example, the thickness T may be less than 3.0 mm. In one embodiment, the thickness T may be 1.0 mm or less.

According to an additional embodiment, a robot arm 417 may comprise a plurality of clamping members 452. Such an embodiment is illustrated in the overhead plan view shown in FIG. 4C. As shown, three separate clamping members 452 extend out from the end effector wrist 418, though embodiments are not limited to such configurations and embodiments may also include two or more clamping members. As shown, the clamping members 452 extend outward from the end effector wrist and are able to clamp down along a top surface of the carrier ring 432. As illustrated, the carrier ring 432, the substrate 422 and the backing tape 434 are shown with dashed lines and are transparent in order to not obscure the figure.

In an embodiment, each clamping member 452 is controlled by a separate actuator 454. The use of separate actuators allows for an increased clamping force to be applied to the carrier ring 432 without needing to increase the height of the end effector wrist 418 in order to fit a larger and stronger actuator. For example, the actuators 454 may be aligned along the width W of the end effector wrist 418. Not having to increase the height of the end effector wrist 418 may be beneficial when passing the carrier ring assembly through the first load lock opening 315. In an embodiment, the end effector wrist 418 may need to pass through the first opening 315 in order to position the carrier ring assembly on the pedestal 321. Accordingly, if the height of the end effector wrist is increased, then the robot arm 417 may not fit through the opening. For example, the height of the end effector wrist 418 may be approximately 20 mm and the first opening 316 may be only slightly larger. Minimizing the height of the end effector wrist prevents the need for a redesign of the load lock 307. Therefore, equipment designed for transferring substrates, such as silicon wafers that are not supported by carrier rings, may be repurposed for use in the processing of substrates 422 supported by carrier rings 432 without significant redesign costs when embodiments of the invention are utilized.

Increasing the clamping force also allows for the robot 390 to move faster while transferring a carrier ring assembly from a first location to a second location. Accordingly, embodiments that utilize multiple clamping members 452 may allow for an increased throughput. Though each clamping member 452 is shown as being coupled to its own actuator 454, embodiments are not limited to such configurations. For example, a single actuator 454 may control two or more clamping members 452. Additionally, a plurality of actuators 454 may be used to control a single clamping member 452.

Referring now to FIG. 4D, a cross-sectional illustration of a robot arm according to an additional embodiment is shown. The robot arm of FIG. 4D is substantially similar to the robot arm illustrated in FIG. 4B, with the exception that a pad layer 461 is formed on surfaces that contact the carrier ring assembly. In an embodiment, the pad layer 461 may be approximately 1.0 mm thick or less. Additional embodiments include a pad layer that may be 0.5 mm thick or less. In an embodiment, the pad layer 461 may be a compliant material, such as a rubber or other polymeric material. According to an embodiment of the invention, the pad layer 461 may be a material that has a compliance between 50 and 100 Durometer. Embodiments of the invention may include a pad layer 461 that has a compliance between 55 and 70 Durometer.

The use of a compliant material increases the contact area between the carrier ring assembly and the end effector 419. For example, an end effector 419 formed from a rigid material may not allow the entire surface of the carrier ring 432 to contact the end effector 419 due to the variation in thickness of the carrier ring 432, which may be 0.1 mm or greater. In contrast, a compliant pad layer 461 can conform to the variations in thickness of the carrier ring 432 and provide improved contact between the two surfaces. As illustrated, the pad layer is formed over a surface of the end effector 419 and the clamping member 452, though embodiments are not limited to such configurations. For example, a pad layer 461 may be formed over only the end effector 419 or only over the clamping member 452. In an additional embodiment, the pad layer 461 may be formed over portions of the end effector and/or clamping member 452 that are expected to make contact with the carrier ring 432.

Embodiments of the invention may attach the pad layer 461 to the end effector 419 and/or the clamping member with an adhesive. The use of an adhesive allows for the pad layer to be easily replaceable when it becomes worn. Furthermore, since embodiments include a robot arm 417 that is within the factory interface, replacement of the pad layer 461 does not require extensive down time for the process tool 300. For example, replacing the pad layer 461 would not require the machine to be recertified since the portions of the tool that are maintained at vacuum (e.g., the transfer chamber 309 or process chambers 337) may not need to be opened during the replacement of the pad layer 461. Accordingly, throughput of the tool 300 is not adversely effected by use of a pad layer 461.

Referring now to FIG. 4E, a cross-sectional illustration of a robot arm according to an additional embodiment is shown. The robot arm of FIG. 4E is substantially similar to the robot arm illustrated in FIG. 4B, with the exception that the thickness of the end effector 419 is not uniform across its length. In an embodiment, a thickness of the end effector 419 proximate to the end effector wrist 418 may have a first thickness T₁ and the thickness proximate to the opposite end of the end effector 419 may have a second thickness T₂. According to an embodiment, T₁ may be greater than T₂. By way of example, T₁ may be at least twice as large as T₂. For example, T₁ may be approximately 2.0 mm and T₂ may be approximately 1.0 mm. As illustrated, the thickness is tapered on a bottom surface of the end effector 419 in order to ensure a surface parallel to the ground is maintained on the top surface of the end effector 419. Embodiments that utilize such a tapered configuration may further reduce the mass of the end effector 419. As such, the drooping of the end effector 419 may be reduced.

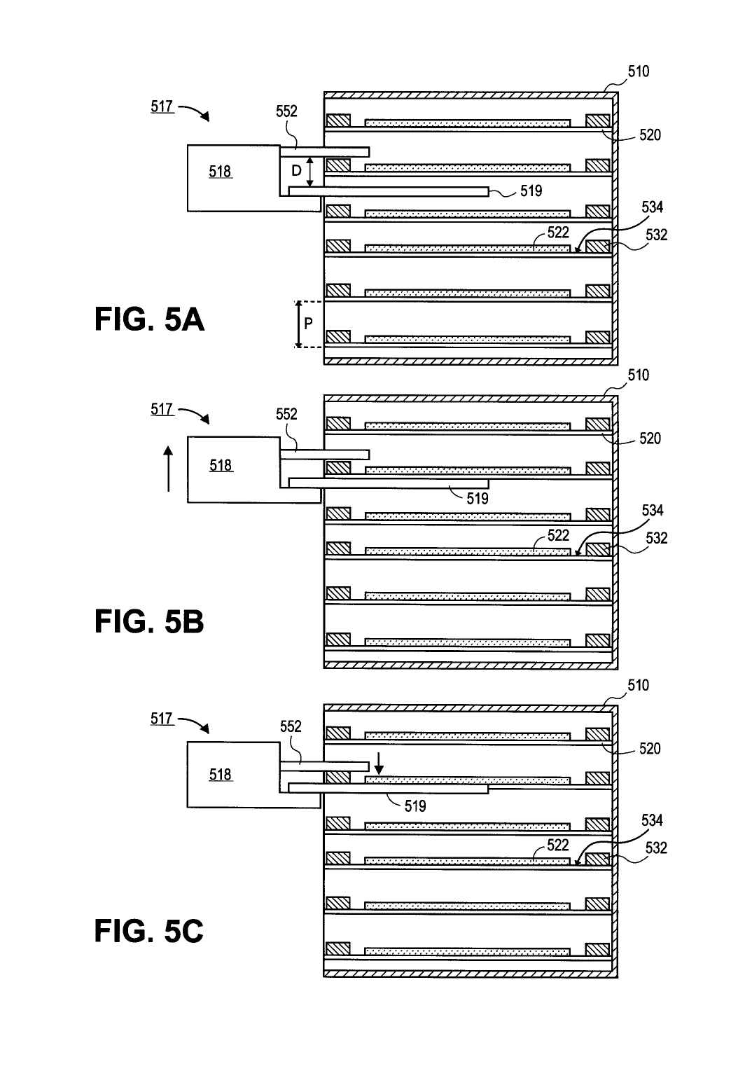

According to embodiments of the invention, the addition of a clamping member above the end effector does not prevent the robot arm from picking up a carrier ring assembly stored on a slot in a tightly pitched FOUP or cassette. As shown in the cross-sectional illustrations in FIGS. 5A-5C, the robot arm 517 is able to insert both the end effector 519 and the clamping member 552 into a FOUP 510. Referring now to FIG. 5A, a robot arm 517 may be inserted into the FOUP 510 with the end effector 519 inserted below a bottom surface of a carrier ring 532 and the clamping member 552 inserted above the top surface of the carrier ring 532. According to an embodiment, the distance D between the clamping member 552 and the end effector 519 may be greater than the pitch P between slots 520.

Referring now to FIG. 5B, the robot arm 517 is raised upwards to contact the bottom surface of the carrier ring assembly 530, as indicated by the arrow. While the end effector wrist 518 and the end effector 519 are raised, the clamping member 552 is displaced towards the end effector 519 by the actuator (not shown). Accordingly, the clamping member 552 may remain in substantially the same position relative to the carrier ring 532.

Referring now to FIG. 5C, the clamping member 552 may be displaced towards the end effector 519 until the clamping member 552 contacts the carrier ring 532, as indicated by the arrow. When the carrier ring 532 has been secured, the robot arm 517 may retract from the FOUP 510 and transfer the carrier ring assembly 530 to a second location, such as the load lock 307 or the laser scribe 308.

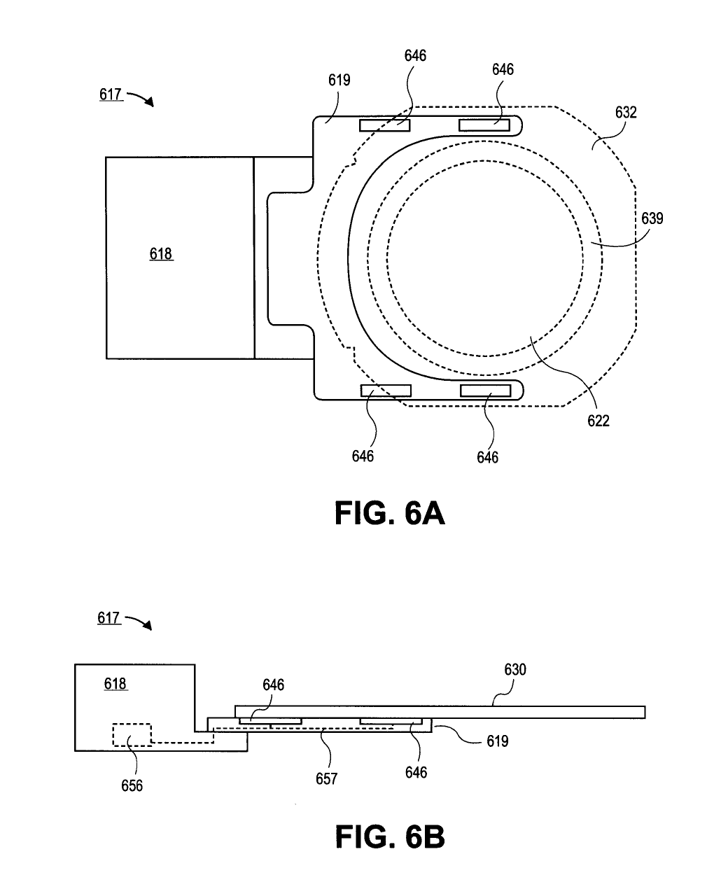

Embodiments of the invention may also include gripping devices in addition to a clamping member or in replacement of a clamping member. Referring now to FIG. 6A, an overhead plan view of a robot arm 617 according to an additional embodiment is illustrated. As illustrated, embodiments of the invention may include a gripping device that is an electromagnet. Such embodiments, are particularly useful when the carrier ring assembly that is being transferred comprises a magnetic carrier ring 132. A magnetic gripping force supplied by the electromagnets may secure the carrier ring assembly to the end effector 619 instead of relying on a mechanical force. In an embodiment the end effector 619 is positioned relative to the carrier ring 632 to ensure that the electromagnetic inserts 646 are positioned below the carrier ring 632.

According to an embodiment, one or more electromagnetic inserts 646 may be inserted along portions of the end effector 619. In FIG. 6A, four electromagnetic inserts 646 are illustrated, but embodiments are not limited to such configurations. For example, embodiments may include as few as one electromagnetic insert 646, or more than four electromagnetic inserts. Embodiments also include electromagnetic inserts 646 that are larger or smaller in size than the inserts illustrated in FIG. 6A. For example, a single insert may extend substantially along the entire length of each arm of the end effector 619.

In an embodiment, a top surface of the electromagnetic inserts 646 are coplanar with top surfaces of the end effector 619, as shown in the cross-sectional view illustrated in FIG. 6B. In an embodiment, each electromagnetic insert 646 is electrically coupled to a control circuit 656, as indicated by the dashed lines 657 in FIG. 6B. In an embodiment, the control circuit 656 may activate or deactivate the flow of electrical current to the electromagnetic inserts 646 in order to activate or deactivate the magnetic force. By way of example, the control circuit 656 may be located in the end effector wrist 618. Additional embodiments include a control circuit 656 that is located at any location within the robot that may be electrically coupled to the electromagnetic inserts 646.

According to an embodiment, the electromagnetic inserts 646 may be electrically coupled to the control circuit 656 by conductive wires inserted into the end effector 619. For example, in a non-conductive end effector 619, such as an alumina end effector, conductive wires may be included within the end effector 619. In an additional embodiment, the electromagnetic inserts 646 may be electrically coupled to the control circuit 656 by the end effector 619. For example, embodiments that include an end effector 619 that is formed from a conductive material, may provide an electrical path between the control circuit 656 and the electromagnetic inserts 646. After the end effector 619 is completed, recesses may be drilled into the top surface of the end effector 619 that are sized to receive the electromagnetic inserts 646.

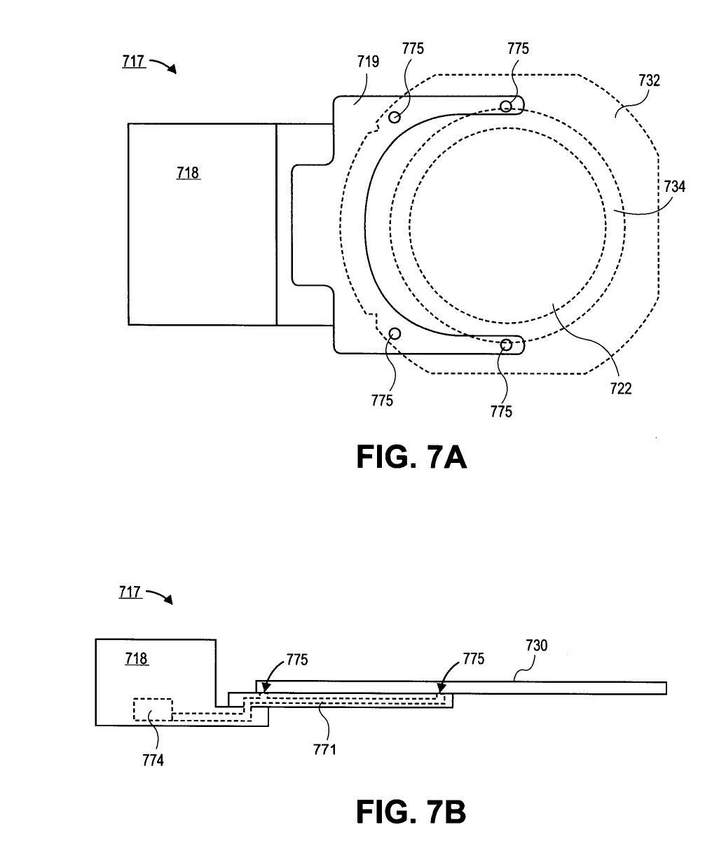

Referring now to FIGS. 7A and 7B, an overhead plan view and a cross-sectional view of a robot arm 717 according to an additional embodiment is illustrated. As shown, embodiments of the invention may include a gripping device that includes one or more openings 775 coupled to air-lines 771 formed into the end effector. In an embodiment, air-lines 771 may already be present in the end effector wrist 718, and as such will not add additional complexity or increase the cost of the robot arm. For example, the air-lines may be used for driving pneumatic actuators that control the position of the robot arm 717. In an embodiment, a vacuum controller 774 may be coupled to the air-lines 771 and be used to activate or deactivate a vacuum to secure or release the carrier ring assembly 730 that is supported by the end effector 719. In an embodiment, the vacuum controller 774 may be positioned in the end effector wrist, as illustrated in the cross-sectional view shown in FIG. 7B. Additional embodiments include a vacuum controller 774 that is located at any location within the robot that may be coupled to the air-lines 771 in the end effector 719.

Embodiments that utilize a vacuum gripping device may be beneficial because the vacuum pressure may be applied to the carrier ring 732 or the backing tape 734. Accordingly, the openings 775 do not need to be aligned under the carrier ring in order to ensure that the carrier ring assembly is secured. As illustrated, four openings 775 are formed into the end effector 719, though embodiments are not limited to such configurations. For example, embodiments include as few as one opening 775 or more than four openings 775.

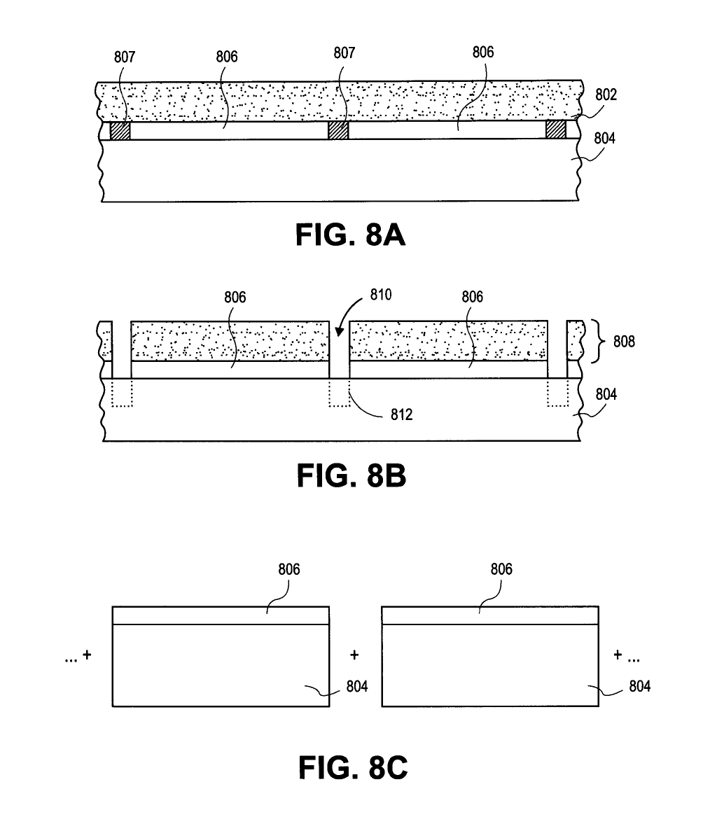

According to an embodiment, carrier ring assemblies that are transferred by a robot arm according to embodiments described herein may be processed in a processing tool, such as processing tool 300 described in FIG. 3A. In an embodiment, processing may include a hybrid laser and etch singulation process. For example, a hybrid laser and etch singulation process may include a process such as the one illustrated in FIGS. 8A-8C. Referring to FIG. 8A, a mask 802 is formed above a semiconductor wafer or substrate 804. The mask 802 is composed of a layer covering and protecting integrated circuits 806 formed on the surface of semiconductor wafer 804. The mask 802 also covers intervening streets 807 formed between each of the integrated circuits 806.

Referring to FIG. 8B, the mask 802 is patterned with a laser scribing process to provide a patterned mask 808 with gaps 810, exposing regions of the semiconductor wafer or substrate 804 between the integrated circuits 806. As such, the laser scribing process is used to remove the material of the streets 807 originally formed between the integrated circuits 806. In accordance with an embodiment of the present invention, patterning the mask 802 with the laser scribing process further includes forming trenches 812 partially into the regions of the semiconductor wafer 804 between the integrated circuits 806, as depicted in FIG. 8B.

Referring to FIG. 8C, the semiconductor wafer 804 is etched through the gaps 810 in the patterned mask 808 to singulate the integrated circuits 806. In accordance with an embodiment of the present invention, etching the semiconductor wafer 804 includes ultimately etching entirely through semiconductor wafer 804, as depicted in FIG. 8C, by etching the trenches 812 initially formed with the laser scribing process. In one embodiment, the patterned mask 808 is removed following the plasma etching, as is also depicted in FIG. 8C.

Accordingly, referring again to FIGS. 8A-8C, wafer dicing may be performed by initial ablation using a laser scribing process to ablate through a mask layer, through wafer streets (including metallization) and, possibly, partially into a substrate or wafer. Die singulation may then be completed by subsequent through-substrate plasma etching, such as through-silicon deep plasma etching.

Embodiments of the present invention may be provided as a computer program product, or software, that may include a machine-readable medium having stored thereon instructions, which may be used to program a computer system (or other electronic devices) to perform a process according to embodiments of the present invention. In one embodiment, the computer system is coupled with process tool 300 described in association with FIG. 3A. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

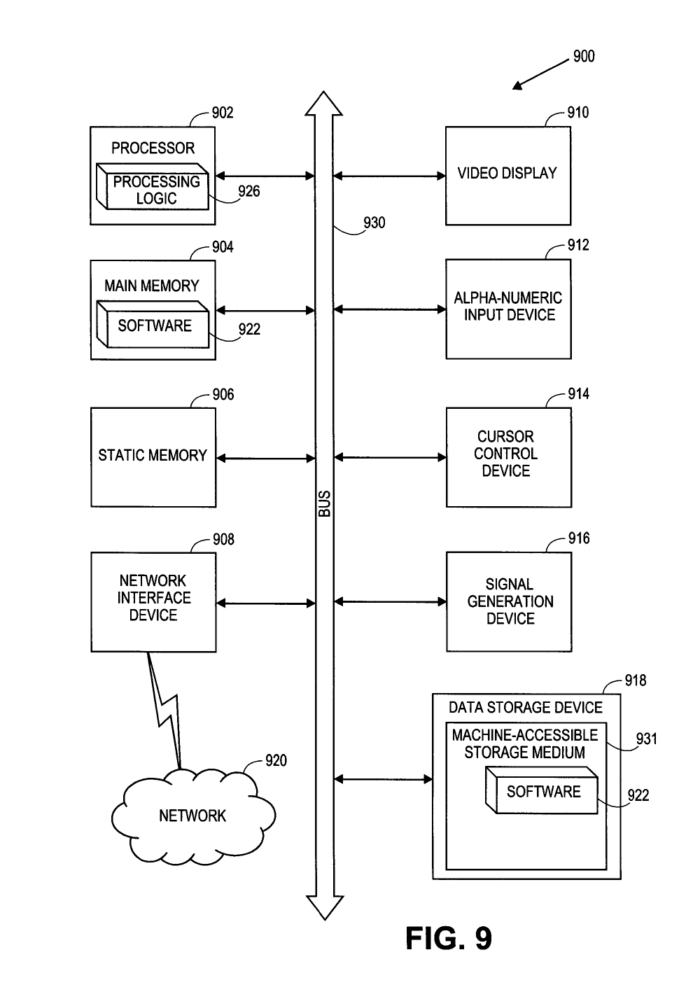

FIG. 9 illustrates a diagrammatic representation of a machine in the exemplary form of a computer system 900 within which a set of instructions, for causing the machine to perform any one or more of the methodologies described herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies described herein.

The exemplary computer system 900 includes a processor 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a secondary memory 918 (e.g., a data storage device), which communicate with each other via a bus 930.

Processor 902 represents one or more general-purpose processing devices such as a microprocessor, central processing unit, or the like. More particularly, the processor 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 902 may also be one or more special-purpose processing devices such as an application specific integrated circuit (ASIC), a field programmable gate array (FPGA), a digital signal processor (DSP), network processor, or the like. Processor 902 is configured to execute the processing logic 926 for performing the operations described herein.

The computer system 900 may further include a network interface device 908. The computer system 900 also may include a video display unit 910 (e.g., a liquid crystal display (LCD), a light emitting diode display (LED), or a cathode ray tube (CRT)), an alphanumeric input device 912 (e.g., a keyboard), a cursor control device 914 (e.g., a mouse), and a signal generation device 916 (e.g., a speaker).

The secondary memory 918 may include a machine-accessible storage medium (or more specifically a computer-readable storage medium) 931 on which is stored one or more sets of instructions (e.g., software 922) embodying any one or more of the methodologies or functions described herein. The software 922 may also reside, completely or at least partially, within the main memory 904 and/or within the processor 902 during execution thereof by the computer system 900, the main memory 904 and the processor 902 also constituting machine-readable storage media. The software 922 may further be transmitted or received over a network 920 via the network interface device 908.

While the machine-accessible storage medium 931 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of embodiments of the present invention. The term “machine-readable storage medium” shall accordingly be taken to include, but not be limited to, solid-state memories, and optical and magnetic media.

In accordance with an embodiment of the present invention, a machine accessible storage medium has instructions stored thereon which cause a data processing system to perform a method of inserting a robot arm into a FOUP, with the end effector positioned below a bottom surface of the carrier ring assembly, and the clamping member positioned above the carrier ring assembly. The method may further include raising the end effector to contact the bottom surface of the carrier ring assembly. In an embodiment, the clamping member may be displaced relative to the end effector as the robot arm is raised to contact the carrier ring assembly. The method may further include displacing the clamping member until the clamping member contacts a top surface of the carrier ring assembly. The method may further include removing the robot arm and the carrier ring assembly from the FOUP.

Embodiments of the invention described herein include several embodiments for allowing a robot arm to remove a carrier ring assembly from a FOUP with tightly pitched slots. Those skilled in the art will further recognize that each of the embodiments described herein may be used in isolation, or in any combination. For example, a robot arm may comprise a clamping member and a vacuum gripping device. Additional embodiments include a robot arm that may comprise a clamping member, a tapered end effector, and electromagnetic inserts. Further embodiments may include a robot arm that comprises a pad layer formed over a tapered end effector that includes openings that are coupled to a vacuum controller.

1. A robot arm comprising:
an end effector wrist;
an end effector coupled to the end effector wrist, wherein a thickness of the end effector is tapered from a first thickness proximate to the end effector wrist to a second thickness at an end of the end effector that is opposite the end effector wrist, wherein the first thickness is greater than the second thickness; and
a gripping device coupled to the end effector wrist for securing a carrier ring assembly to the end effector.

2. The robot arm of claim 1, wherein the gripping device comprises a first clamping member, the clamping member extending out from the end effector wrist above the end effector, wherein one or more first actuators displace the first clamping member relative to the end effector.

3. The robot arm of claim 2, wherein at least one of the first actuators is an electric actuator.

4. The robot arm of claim 2, wherein at least one of the first actuators is a pneumatic actuator.

5. The robot arm of claim 2, further comprising a second clamping member extending out from the end effector wrist above the end effector, wherein one or more second actuators displace the second clamping member relative to the end effector.

6. (canceled)

7. The robot arm of claim 1, wherein a pad layer is formed over a top surface of the end effector.

8. The robot arm of claim 7, wherein the pad layer has a compliance between 50 and 100 Durometer.

9. The robot arm of claim 7, where the pad layer has a compliance between 75 and 85 Durometer.

10. The robot arm of claim 1, wherein the gripping device is an electromagnetic device.

11. The robot arm of claim 10, wherein the electromagnetic device comprises a plurality of electromagnets that are inserted into a top surface of the end effector and are electrically coupled to a control circuit that activates and deactivates the electromagnets.

12. The robot arm of claim 1, wherein the gripping device is a vacuum device.

13. The robot arm of claim 12, wherein the vacuum device comprises one or more openings in the top surface of the end effector, wherein the one or more openings are coupled to a vacuum controller in the end effector wrist by air-lines formed in the end effector.

14. A method of removing a carrier ring assembly from a substrate carrier, comprising:
inserting an end effector and a clamping member into the substrate carrier, wherein the end effector and the clamping member are coupled to an end effector wrist, and wherein the end effector is below a bottom surface of the carrier ring assembly and the clamping member is above a top surface of the carrier ring assembly;
contacting a bottom surface of the carrier ring assembly with the end effector wrist by raising the end effector wrist, wherein the clamping member is displaced relative to the end effector as the end effector wrist is raised; and
displacing the clamping member towards the end effector until the clamping member contacts the top surface of the carrier ring assembly.

15. The method of claim 14, further comprising:
removing the end effector, the clamping member and the and the carrier ring assembly from the substrate carrier; and
transferring the carrier ring assembly to a second location.

16. The method of claim 14, wherein the clamping member is controlled with one or more actuators located in the end effector wrist.

17. The method of claim 14, wherein the end effector has a thickness less than approximately 3.0 mm.

18. The method of claim 14, wherein a pad layer having a compliance between 50 and 100 Durometer is formed over surfaces of the end effector that contact the carrier ring assembly.

19. A robot arm comprising:
an end effector wrist;
an end effector having coupled to the end effector wrist and having a maximum thickness less than approximately 3.0 mm, wherein a thickness of the end effector is tapered from a first thickness proximate to the end effector wrist to a second thickness at an end of the end effector that is opposite the end effector wrist, wherein the first thickness is greater than the second thickness;
a gripping device coupled to the end effector wrist for securing a carrier ring assembly to the end effector, wherein the gripping device comprises a first clamping member, the clamping member extending out from the end effector wrist above the end effector, wherein one or more first actuators displace the first clamping member in a first direction relative to the end effector; and
a pad layer formed over a top surface of the end effector and over a bottom surface of the clamping member.

20. The robot arm of claim 19 further comprising, an electromagnetic gripping device that comprises a plurality of electromagnets that are inserted into a top surface of the end effector and are electrically coupled to a control circuit in the end effector wrist that can activate and deactivate the electromagnets.
